(19) United States
(12) Patent Application Publication
(10) Pub. No.: US 2011/0267599 A1
(43) Pub. Date: Nov. 3, 2011

(54) SYSTEMS, METHODS, DEVICES, AND COMPUTER READABLE MEDIA FOR TERAHERTZ RADIATION DETECTION

(75) Inventor: David Howard Hurley, Idaho Falls, ID (US)

(73) Assignee: Battelle Energy Alliance, LLC, Idaho Falls, ID (US)

(21) Appl. No.: 12/772,822

(22) Filed: May 3, 2010

(51) Int. Cl. G01B 9/02; G01J 3/00

(52) U.S. Cl. 356/51; 356/521

(57) ABSTRACT

Systems, devices, methods, and computer-readable media relating to terahertz radiation detection are disclosed. A method of detecting terahertz radiation may include transmitting a reference beam and a signal beam through a common-path interferometer. The method may further include transmitting a terahertz beam through a target object. Furthermore, the method may include causing the signal beam and the terahertz beam to simultaneously propagate through an electro-optical element within the common-path interferometer after transmitting the terahertz beam through the target object to induce a phase delay between the signal beam and the reference beam. In addition, the method may include calculating the phase delay and calculating an amplitude of an electric field of the terahertz beam from the phase delay.

### GOVERNMENT RIGHTS

This invention was made with government support under Contract Number DE-AC07-051D14517 awarded by the United States Department of Energy. The government has certain rights in the invention.

### TECHNICAL FIELD

Embodiments of the present invention relate generally to radiation detection and, more specifically, to systems, devices, methods, and computer-readable media for detection of terahertz radiation using interferometry.

### BACKGROUND

Various imaging systems and inspection systems are used currently in a wide range of applications. For example, imaging systems are often used for identifying, diagnosing, and treating medical conditions. Similarly, imaging systems and inspection systems of various configurations may be utilized in non-medical applications, such as in industrial quality control as well as in security screening of personnel, passenger luggage, packages, and cargo. For example, inspection systems are employed at various public and private installations, such as airports, for the screening of employees and passengers, luggage, packages and cargo, to detect the presence of contraband (e.g., weapons, explosives and drugs).

Recently, there has been a rapid expansion in the areas of application of terahertz (THz) technology, including apparatuses and components using THz technology. Electromagnetic radiation in the THz range (about 0.1 THz to 10 THz), which is also referred to as “THz radiation” or “millimeter waves” has been used in various applications, such as nondestructive testing, medical imaging, dental imaging, multi-spectral imaging and so forth. Furthermore, over the past several years, there has been an emerging interest in the potential of THz radiation for security related applications, such as imaging of concealed weapons, and detection of explosives and chemical and biological weapons.

Terahertz radiation is readily transmitted through most non-metallic and non-polar media (e.g., clothing, paper, wood, semiconductors, plastics, and packaging materials), which enables THz radiation-based imaging systems to “see through” otherwise concealing barriers in order to probe materials contained within. Additionally, many materials of interest for security applications including explosives and chemical and biological agents have associated, characteristic THz spectra, which may be used in a THz radiation-based inspection system to “fingerprint” and identify concealed materials of these types. Thus, the combination of transparency of clothing and packaging to THz radiation, combined with the ability to employ THz radiation-based spectroscopy to identify illicit materials such as narcotics, biological weapons, or explosives may enable rapid and accurate detection and identification of many different types of materials. Furthermore, THz radiation is non-destructive to objects being scanned and is believed to pose no more than minimal health risks to either a person being scanned or an operator of a detection system. Accordingly, THz technology offers significant advantages in the field of contraband detection.

There is a need for enhanced detection of terahertz radiation using a common-path interferometer. Specifically, there is a need for methods, devices, systems and computer-readable media for measuring a temporal electric field of terahertz radiation via optical phase detection.

### BRIEF SUMMARY

An embodiment of the present invention comprises a method of detecting terahertz radiation. The method may include transmitting a reference beam and a signal beam through a common-path interferometer. The method may further include transmitting a terahertz beam through a target object. Furthermore, the method may include causing the signal beam and the terahertz beam to simultaneously propagate through an electro-optical element within the common-path interferometer after transmitting the terahertz beam through the target object to induce a phase delay between the signal beam and the reference beam. In addition, the method may include calculating the phase delay, and calculating an amplitude of an electric field of the terahertz beam from the phase delay.

Another embodiment of the present invention includes yet another method of detecting terahertz radiation. The method may comprise irradiating a target object with a terahertz beam. Additionally, the method may include inducing a phase delay between a reference beam and a signal beam by simultaneously transmitting the signal beam and the terahertz beam through an electro-optical element in a common-path interferometer. The method may further include calculating the phase delay and determining an amplitude of an electric field of the terahertz beam as a function of time from the phase delay. Additionally, the method may include generating frequency spectra from the amplitude of the electric field of the terahertz beam as a function of time.

Another embodiment of the present invention includes a detection system. The detection system may comprise a light source configured to transmit a source beam. Further, the detection system may include an interferometer configured to receive the source beam and an electro-optical element positioned for receiving a terahertz beam incident thereon. The interferometer is configured to generate a signal beam and a reference beam from the source beam and induce a phase delay between the signal beam and the reference beam in response to the signal beam and the terahertz beam simultaneously traversing the electro-optical element. The interferometer is further configured to form a mixed beam by interfering the signal beam with the reference beam. The detection system may further include a sensor configured to measure an intensity of the mixed beam upon receipt thereof.

Another embodiment of the present invention includes an interferometer. The interferometer may comprise a reference path and a measurement path, wherein the measurement path includes an electro-optical element configured to induce a phase delay in a beam traversing therethrough upon receiving a terahertz beam incident thereon.

Yet another embodiment of the present invention includes a computer-readable storage medium storing instructions that, when executed by a processor, cause the processor to perform instructions for detecting terahertz radiations according to an embodiment of the present invention.

### BRIEF DESCRIPTION OF THE DRAWINGS

FIG. 1 illustrates a block diagram of a detection system, according to an embodiment of the present invention;

FIG. 2 illustrates a target object and a portion of a detection system including a common-path interferometer, in accordance with an embodiment of the present invention;

FIGS. 3A and 3B illustrate conventional terahertz generation systems;

FIGS. 4A and 4B each depict a target object and a portion of a detection system including a common-path interferometer and associated light beam paths, in accordance with an embodiment of the present invention;

FIGS. 5A, 5B, and 5C each illustrate a relationship between a signal beam and a reference beam at various stages within a common-path interferometer, in accordance with an embodiment of the present invention;

FIG. 6 illustrates a portion of a detection system including an interferometer having optical fibers, according to an embodiment of the present invention;

FIG. 7 is an example plot illustrating an amplitude of an electric field of a terahertz beam as a function of time; and

FIG. 8 is an example plot illustrating an amplitude of an electric field of a terahertz beam in a frequency domain.

### DETAILED DESCRIPTION

In the following detailed description, reference is made to the accompanying drawings which form a part hereof and, in which is shown by way of illustration, specific embodiments in which the invention may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, functions may be shown in block diagram form in order not to obscure the present invention in unnecessary detail. Furthermore, specific implementations shown and described are only examples and should not be construed as the only way to implement the present invention unless specified otherwise herein. Block definitions and partitioning of logic between various blocks represent a specific, non-limiting implementation. It will be readily apparent to one of ordinary skill in the art that the various embodiments of the present invention may be practiced by numerous other partitioning solutions. For the most part, details concerning timing considerations, and the like, have been omitted where such details are not necessary to obtain a complete understanding of the present invention in its various embodiments and are within the abilities of persons of ordinary skill in the relevant art.

When executed as firmware or software, instructions for performing the methods and processes described herein may be stored on a computer readable medium. A computer readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

Referring in general to the following description and accompanying drawings, various embodiments of the present invention are illustrated to show its structure and method of operation. Common elements of the illustrated embodiments are designated with like numerals. It should be understood that the figures presented are not meant to be illustrative of actual views of any particular portion of the actual structure or method, but are merely idealized representations, which are employed to more clearly and fully depict the present invention.

As will be understood by a person having ordinary skill in the art, methods of detecting and characterizing concealed threats may comprise using pulses of THz electromagnetic radiation (hereinafter “THz pulses”) to spectroscopically detect and identify concealed materials through their characteristic transmission or reflectivity spectra in the range of 0.1-10 THz. For example, materials, such as explosives (e.g., C-4, HMX, RDX and TNT) and illegal drugs (e.g., methamphetamine) may have characteristic transmission, reflection or both transmission and reflection spectra in the THz range that may be distinguishable from other materials such as clothing, coins, and human skin. In contrast to optical spectroscopes, THz time-domain spectroscopes may measure a temporal electric field of detected THz pulses. Accordingly, as will be understood by one of ordinary skill in the art, both real (i.e., refractive index) and imaginary (i.e., absorption coefficient) parts of a dielectric constant of a material of interest, such as a hazardous or other contraband material, may be measured. In essence, these materials may be distinguishable from benign objects, which are not of interest. Furthermore, using THz spectroscopy may enable for detection of explosives or drugs even if they are concealed from sight, since THz radiation is readily transmitted through plastics, clothing, luggage, paper products, and other non-conductive materials. By comparing measured THz spectra with known spectra of illicit materials, it may be possible to identify the presence of an illicit material and distinguish it from benign objects.

As described more fully below, various embodiments of the present invention include systems, devices, methods, and computer-readable media for terahertz detection. More specifically, various embodiments of the present invention are related to systems, devices, methods, and computer-readable media for terahertz radiation detection within a common-path interferometry detection system. Detection systems and interferometers, according to various embodiments of the present invention, will first be described. Thereafter, various contemplated methods of detecting terahertz radiation, in accordance with one or more embodiments of the present invention, will be described.

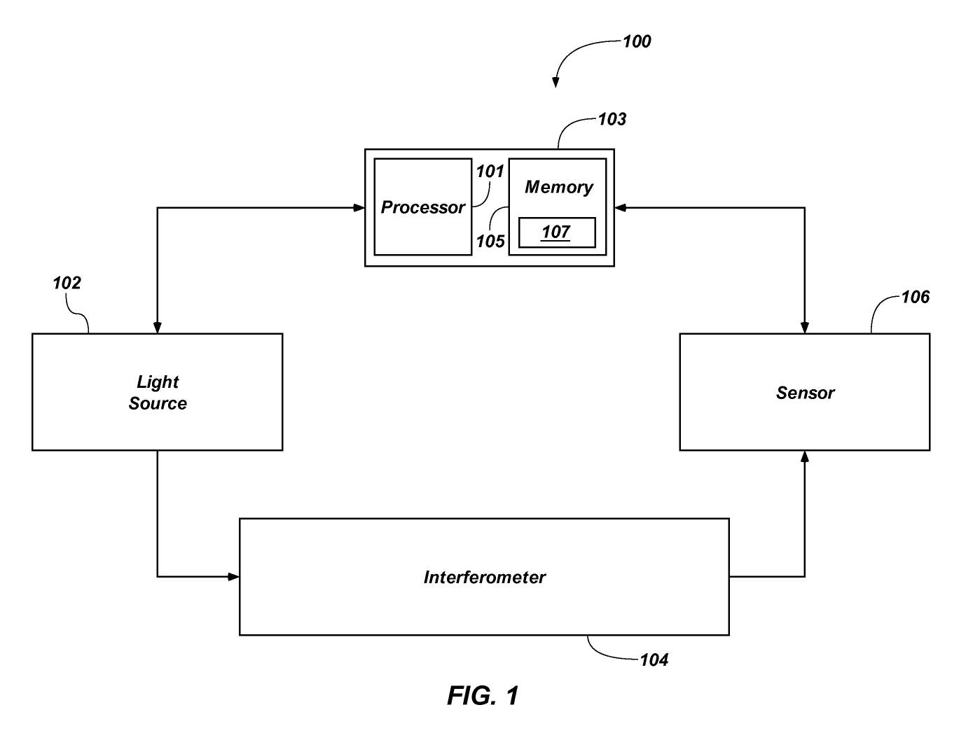

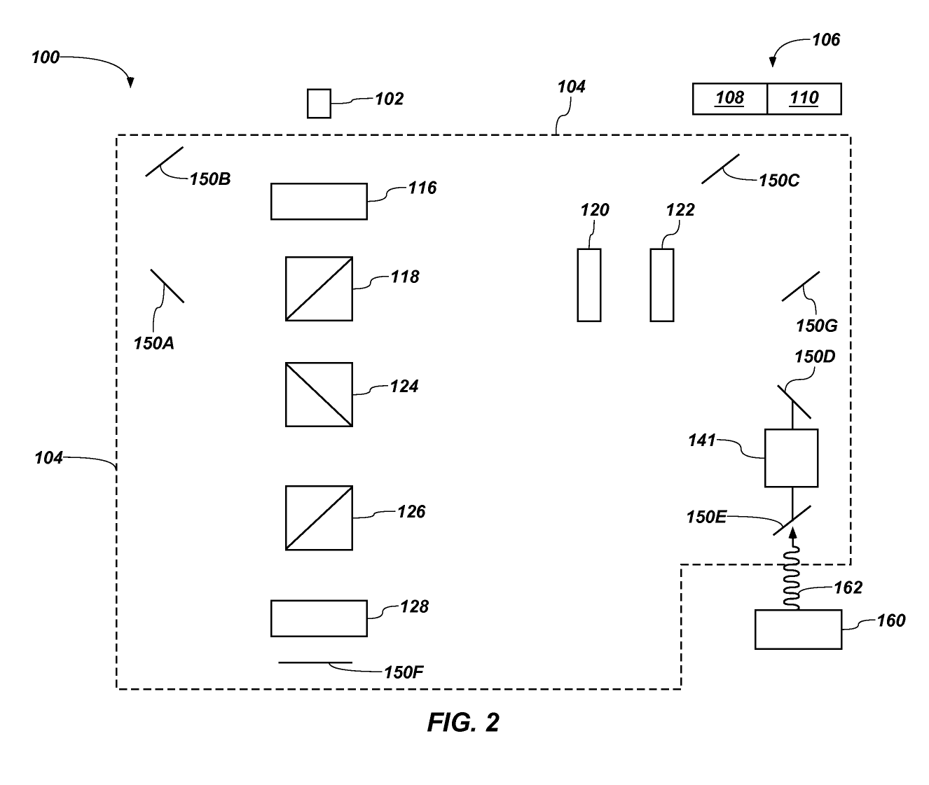

FIG. 1 illustrates a block diagram of a detection system 100, in accordance with an embodiment of the present invention. Detection system 100 may also be commonly referred to hereinafter as an “interrogation system.” Detection system 100 includes a light source 102, an interferometer 104, a sensor 106, and a computer 103. By way of example only, light source 102 may comprise a Ti:sapphire laser having an 800 nm center wavelength, a sub 200 femtosecond pulse duration, and a repetition rate of approximately 76 MHz. For example only, sensor 106 may comprise a multi-cell photodetector. More specifically, in this example, sensor 106 may comprise a first cell 108 and a second cell 110 (see FIG. 2), wherein each of first cell 108 and second cell 110 is configured to receive a light beam incident thereon. Computer 103 may include a processor 101 and a memory 105. Memory 105 may include a computer readable medium (e.g., data storage device 107), which may include, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory. As illustrated, computer 103 may be operably coupled to each of light source 102 and sensor 106. According to an embodiment of the present invention, computer 103 may be configured to control operation of light source 102. Moreover, computer 103 may be configured to receive an output of sensor 106.

With reference to FIG. 2, interferometer 104 includes a half-wave plate 116, a non-polarizing beam splitter 118, a first quarter-wave plate 120, and a polarizer 122. As illustrated, half-wave plate 116 is positioned between light source 102 and non-polarizing beam splitter 118, and first quarter-wave plate 120 is positioned between polarizer 122 and non-polarizing beam splitter 118. In addition, interferometer 104 includes a first polarizing beam splitter 124 positioned between non-polarizing beam splitter 118 and a second polarizing beam splitter 126. Moreover, interferometer 104 includes a plurality of reflectors 150A-150G, wherein each reflector 150A-150G is appropriately positioned for reflecting one or more transmitted beams, as will be described more fully below. For example only, each reflector 150A-150G may comprise a mirror. A second quarter-wave plate 128 is positioned between second polarizing beam splitter 126 and reflector 150F. Furthermore, interferometer 104 includes an electro-optical element 141, which will be described more fully below. According to one embodiment of the present invention, electro-optical element 141 may comprise a zinc telluride (ZnTe) crystal. According to another embodiment, electro-optical element 141 may comprise an ammonium dihydrogen phosphate (ADP) crystal.

Detection system 100 may further include a target object 160 (also referred to herein as an “object of interest”) that is, or includes, a material with respect to which a determination is being made regarding its elemental components. For example, target object 160 may be any item capable of transporting or smuggling explosives. As a more specific example, target object 160 may be a living being, a bag, a storage drum, a box, or any combination thereof. During operation of detection system 100, a terahertz beam 162 in the form of a pulse may propagate from target object 160 toward and through electro-optical element 141.

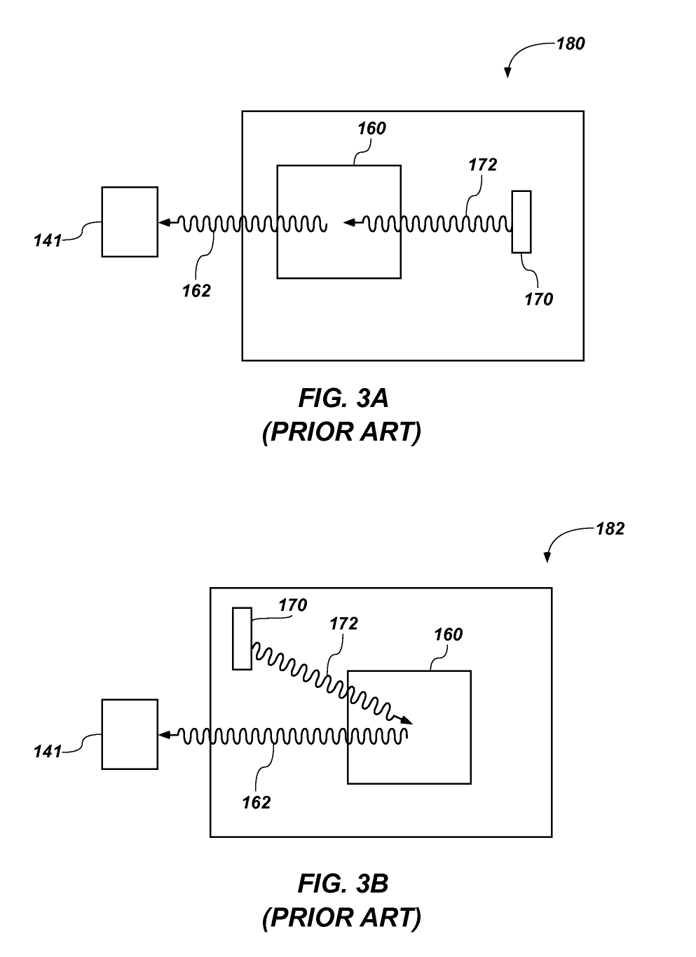

FIGS. 3A and 3B respectively illustrate conventional terahertz generation systems 180 and 182, each of which may be utilized in generating a terahertz beam (e.g., terahertz beam 162). As illustrated, terahertz generation system 180 and terahertz generation system 182 each include a terahertz source 170 and target object 160. As will be understood by a person having ordinary skill in the art, terahertz generation system 180 is configured to operate in a “transmission” mode and terahertz generation system 182 is configured to operate in a “reflection” mode. During operation, terahertz source 170 may generate a terahertz beam 172, which is directed toward, or travels in a direction of, target object 160 and its contents. In a transmission mode (see FIG. 3A), terahertz beam 172 may propagate through target object 160, interact with contents of target object 160, and resultant terahertz beam 162, which is emitted from target object 160, may propagate toward and through electro-optical element 141 (see FIG. 2). In a reflection mode (see FIG. 3B), terahertz beam 172 may propagate into target object 160, interact with contents of target object 160, and reflect as resultant terahertz beam 162, which may propagate toward and through electro-optical element 141. As will be understood by a person having ordinary skill in the art, terahertz source 170 may comprise light source 102, as identified above.

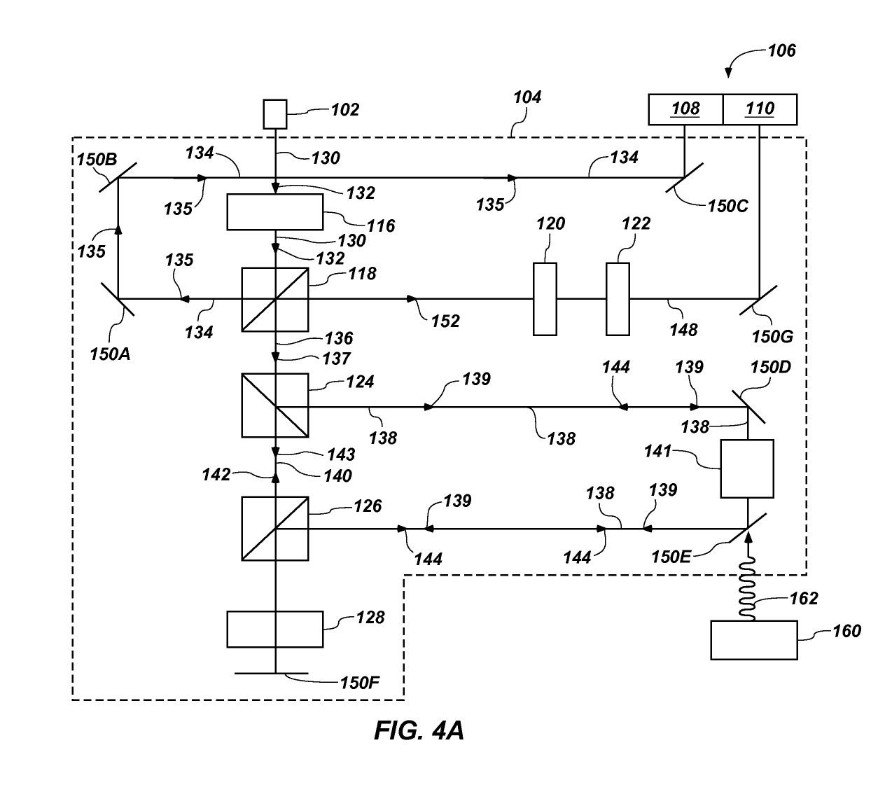

With reference to FIGS. 1, 4A, and 4B, one contemplated mode of operation of detection system 100 will now be described. Initially, a source beam 130 is emitted from light source 102 and transmitted along path 132 through half-wave plate 116 to non-polarizing beam splitter 118. Upon reaching non-polarizing beam splitter 118, source beam 130 is separated into a sampling beam 134, which travels along a sampling path indicated by arrows 135, and a probe beam 136, which travels along a signal path indicated by arrow 137. Upon exiting non-polarizing beam splitter 118, sampling beam 134 is sequentially reflected by reflectors 150A, 150B, and 150C. Thereafter, sampling beam 134 is received by first cell 108 of sensor 106. As will be understood by a person having ordinary skill in the art, sampling beam 134 may be used for common mode rejection of intensity fluctuations of light source 102.

Furthermore, upon reaching first polarizing beam splitter 124, probe beam 136 is separated into a signal beam 138 and a reference beam 140. Signal beam 138 travels along a measurement path indicated by arrows 139 and reference beam 140 travels along a reference path indicated by arrows 143. After being reflected by reflector 150D, signal beam 138 travels through electro-optical element 141 at the same time in which terahertz beam 162 travels through electro-optical element 141. Stated another way, signal beam 138 and terahertz beam 162 simultaneously travel through electro-optical element 141. It is noted that electro-optical element 141 should comprise a material to enable a velocity of a signal beam (i.e., signal beam 138) traversing therethrough and a velocity of a terahertz beam (e.g., terahertz beam 162) incident thereon to be substantially equal. Upon traversing electro-optical element 141, terahertz beam 162 may induce an electro-optical change in a refractive index of electro-optical element 141, which may result in a phase delay of signal beam 138. Stated another way, terahertz beam 162 induces a change in the index of refraction of electro-optical element 141 that is then encoded into the optical phase of signal beam 138.

According to an embodiment of the present invention, electro-optical element 141 should be appropriately positioned and oriented such that the new principle axis of electro-optical element 141 induced by terahertz beam 162 will induce a phase delay in signal beam 138 without altering a polarization of signal beam 138. More specifically, the polarization of signal beam 138 should be parallel with the new principle axis of electro-optical element 141 to prevent alteration of the polarization state of signal beam 138 while allowing for a phase change. For example, wherein electro-optical element 141 comprises a <1 1 0> cut ZnTe crystal, as will be understood by a person having ordinary skill in the art, the new principle axis of electro-optical element 141 induced by terahertz beam 162 should align with the horizontal and vertical components of the <1 1 0> cut ZnTe crystal. Continuing with this example (i.e., electro-optical element 141 comprises a <1 1 0> cut ZnTe crystal), an electric field vector of terahertz wave 162 may be defined as:

$$\vec{E} = \frac{{E}_{0}}{\sqrt{2}} \hat{x} + \frac{{E}_{0}}{\sqrt{2}} \hat{y} ; \qquad ( 1 )$$

wherein E₀ is the amplitude of the electric field of terahertz wave 162, and \hat{x} and ŷ are the respective x and y directions of the electric field of terahertz wave 162. Furthermore, upon application of terahertz wave 162 on electro-optical element 141, the index ellipsoid of electro-optical element 141 may be defined as:

$$\frac{{x}^{2} + {y}^{2} + {z}^{2}}{{n}_{0}^{2}} + 2 {r}_{41} \frac{{E}_{0}}{\sqrt{2}} ( yz + zx ) ; \qquad ( 2 )$$

wherein x, y, and z define the coordinate axes in electro-optical element 141, n₀ is the unperturbed refractive index of electro-optical element 141, and r₄₁ is the relevant electro-optic tensor component. The magnitude of the refractive index of electro-optical element 141 induced by terahertz pulse 162 may be defined by the following eigenvalues:

$${S}_{1} = \frac{1}{{n}_{0}^{2}} , {S}_{2 / 3} = \frac{1}{{n}_{0}^{2}} \pm {r}_{41} {E}_{0} . \qquad ( 3 )$$

Furthermore, the following eigenvectors:

\vec{e}₁=[1 1 0], \vec{e}₂=[1−1\sqrt{2}], \vec{e}₃=[−1 1\sqrt{2}]; (4)

may provide the direction of the new principle axis of electro-optical element 141 induced by terahertz beam 162 and may be used to determine the polarization of signal beam 138 and the polarization of reference beam 140. More specifically, a polarization of signal beam 138 should be aligned along one of the new principle axes of electro-optical element 141 to prevent a change in polarization of signal beam 138 while allowing for change in phase of signal beam 138. As will be understood by a person having ordinary skill in the art, information concerning proper orientation of electro-optical element 141 so as to prevent a change in polarization while allowing for change in phase of signal beam 138 may be provided by a manufacturer of electro-optical element 141.

With continued reference to FIGS. 4A and 4B, after traversing electro-optical element 141, signal beam 138 is reflected by reflector 150E toward second polarizing beam splitter 126. Furthermore, after traversing first polarizing beam splitter 124, reference beam 140 travels to second polarizing beam splitter 126 where reference beam 140 and signal beam 138 are spatially overlapped and transmitted through second quarter-wave plate 128 to reflector 150F. After being reflected by reflector 150F, reference beam 140 and signal beam 138 traverse back through second quarter-wave plate 128 toward second polarizing beam splitter 126. Upon reaching second polarizing beam splitter 126, signal beam 138 is transmitted toward first polarizing beam splitter 124 along a path indicated by arrow 142. Moreover, reference beam 140 is transmitted toward reflector 150E along a path indicated by arrows 144. After being reflected by reflector 150E, traversing electro-optical element 141, and being reflected by reflector 150D, reference beam 140 is again spatially overlapped with signal beam 138 at first polarizing beam splitter 124. It is noted that a terahertz pulse does not traverse electro-optical element 141 at the same time in which reference beam 140 traverses electro-optical element 141 and, therefore, neither a phase nor a polarization of reference beam 140 is modified by electro-optical element 141. Stated another way, because reference beam 140 arrives at and traverses electro-optical element 141 after transmission of terahertz pulse 162 has ceased, neither a phase nor a polarization of reference beam 140 is affected by electro-optical element 141.

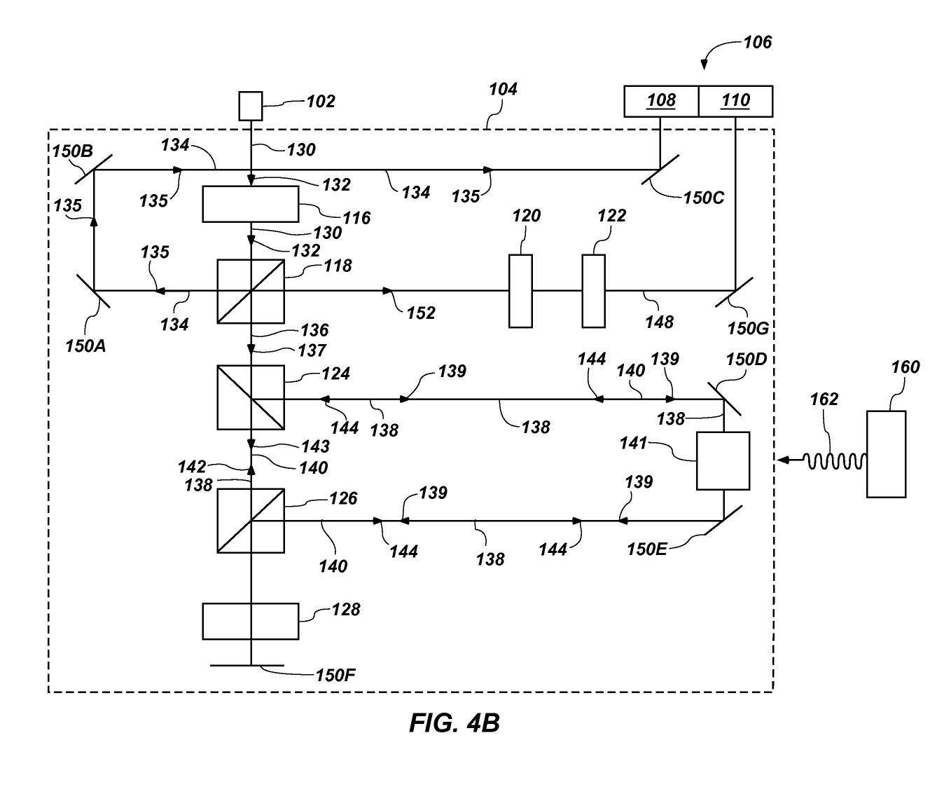

Moreover, upon reaching non-polarizing beam splitter 118, reference beam 140 and signal beam 138, which are spatially overlapped, are reflected toward first quarter-wave plate 120 along a path indicated by arrow 152. With reference to FIGS. 4A and 5A, it is noted that while traveling from non-polarizing beam splitter 118 toward first quarter-wave plate 120, reference beam 140 and signal beam 138 are in phase and have perpendicular polarizations (illustrated by FIG. 5A). After traversing first quarter-wave plate 120, reference beam 140 and signal beam 138 are in phase quadrature (i.e., separated in phase by ninety degrees) and have perpendicular polarizations (illustrated by FIG. 5B). Moreover, after traversing polarizer 122, signal beam 138 and reference beam 140 are in phase quadrature and have parallel polarizations (illustrated by FIG. 5C). Accordingly, signal beam 138 and reference beam 140 may interfere with one another to form mixed beam 148.

As will be understood by one having ordinary skill in the art, components of signal beam 138 and reference beam 140 in mixed beam 148 may interfere with one another so that an intensity of mixed beam 148 varies with the relative phase of signal beam 138 and reference beam 140. After being reflected by reflector 150G, mixed beam 148 is received by second cell 110 of sensor 106 and an intensity of mixed beam 148 may be measured by sensor 106. Furthermore, as will be understood by a person having ordinary skill in the art, the measured intensity of mixed beam 148 may be used to calculate a phase delay, which was caused by a change of an index of refraction of electro-optical element 141 induced by terahertz beam 162. Furthermore, the optical phase delay difference between signal beam 138 and reference beam 140 may be defined as:

$$δφ = \frac{{wn}_{0}^{3} {r}_{41} {E}_{THz} l}{4 c} ; \qquad ( 5 )$$

wherein E_{THz} is the amplitude of signal beam 138, w is the circular frequency of reference beam 140, l is the length of electro-optical element 141, and c is the speed of light in a vacuum. Furthermore, the calculated phase delay may be used to determine an amplitude of an electric field of terahertz beam 162 according to the following equation:

$${E}_{THz} = \frac{4 c δφ}{{wn}_{0}^{3} {r}_{41} l} . \qquad ( 6 )$$

As will be appreciated by a person having ordinary skill in the art, interferometer 104 may demodulate the optical phase of signal beam 138 wherein the optical phase of signal beam 138 is a function of the amplitude of terahertz beam 162.

It is further noted that although terahertz beam 162 is illustrated in FIG. 4A as propagating in a plane that is substantially parallel to a plane in which signal beam 138 traverses electro-optical element 141, embodiments of the invention are not so limited. Rather, as illustrated in FIG. 4B, terahertz beam 162 may travel in a plane that is substantially perpendicular to a plane in which signal beam 138 traverses electro-optical element 141. According to one embodiment wherein electro-optical element 141 comprises a zinc telluride (ZnTe) crystal, terahertz beam 162 may propagate in a plane that is substantially parallel to a plane in which signal beam 138 travels through electro-optical element 141. According to another embodiment wherein electro-optical element 141 comprises an ammonium dihydrogen phosphate (ADP) crystal, terahertz beam 162 may propagate in a plane that is substantially perpendicular to a plane in which signal beam 138 travels through electro-optical element 141.

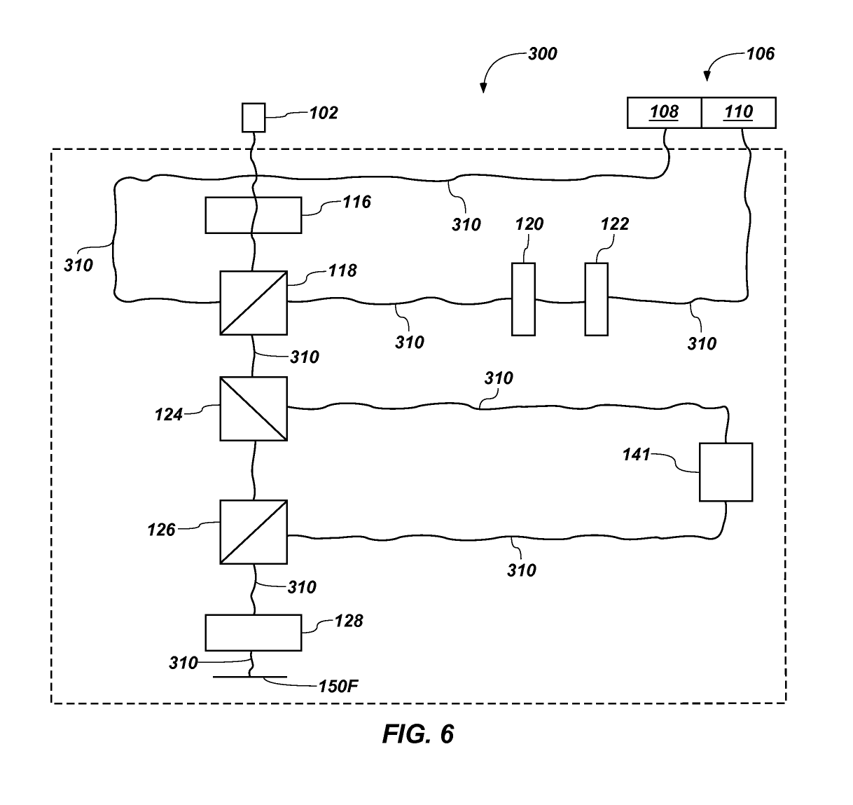

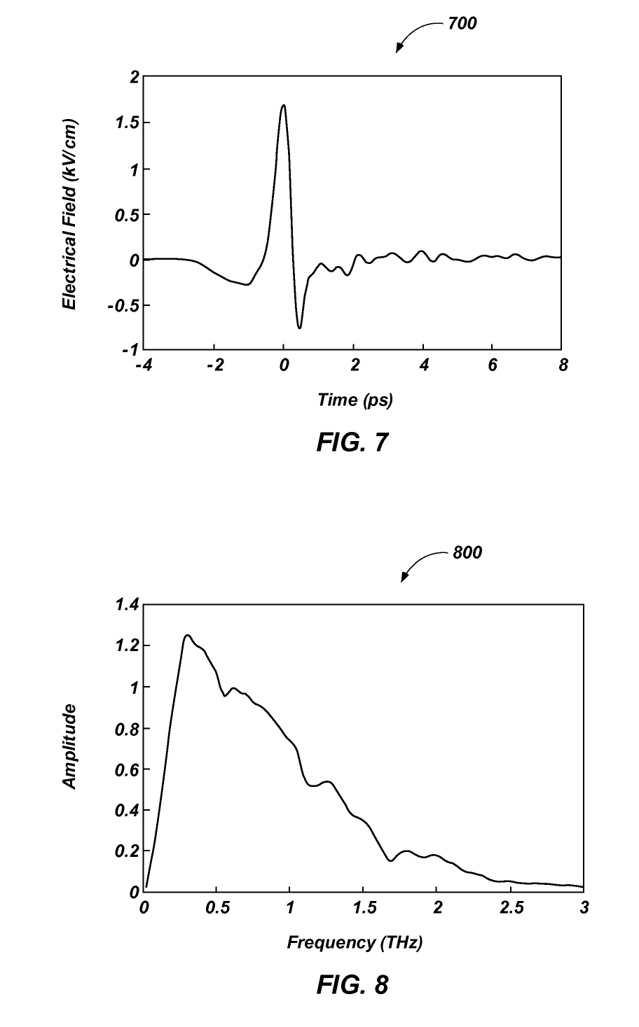

As noted above, terahertz beam 162 and signal beam 138 should simultaneously propagate through electro-optical element 141 at the same velocities. However, as will be understood by a person having ordinary skill in the art, terahertz beam 162 will have a longer duration than signal beam 138. Therefore, a temporal electric field of terahertz beam 162 may be determined by varying the phase between signal beam 138 and terahertz beam 162. Stated another way, by incrementally changing a delay between signal beam 138 and terahertz beam 162 and repeating the method described above for determining an amplitude of an electric field of terahertz beam 162, the electric field of terahertz beam 162 may be measured as a function of time. FIG. 7 is an example plot 700 illustrating an amplitude of an electric field of a terahertz beam as a function of time. Moreover, a Fourier transform may be performed on the time-domain data (i.e., an amplitude of an electric field of a terahertz beam as a function of time) to generate THz spectra associated with terahertz beam 162. FIG. 8 is an example plot 800 illustrating the amplitude of the electric field of the terahertz beam in the frequency domain. The THz spectra (e.g., plot 800) may then be compared to spectra of known materials and a determination may be made as to whether an interrogated material (e.g., target object 160) comprises contraband (e.g., explosives). In addition, by using methods known in the art, an index of refraction and an absorption coefficient of an interrogated material may be determined from the time-domain data. Unlike optical frequencies, the amplitude and phase of a THz beam may be measured, thus, enabling the real and imaginary components of the index of refractions to be determined, as will be understood by a person having ordinary skill in the art.

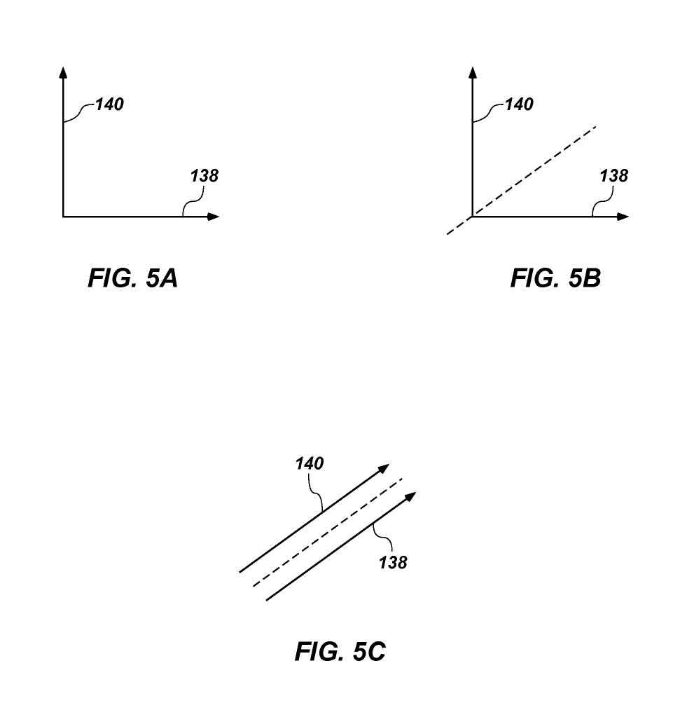

According to one embodiment, detection system 100 is configured so that signal beam 138 and reference beam 140 will travel a common-path length within detection system 100. Therefore, signal beam 138 and reference beam 140 may be spatially overlapped while traveling along the path indicated by arrow 152, which enables signal beam 138 and reference beam 140 to interfere with one another to form mixed beam 148. However, it is noted that embodiments of the present invention are not limited to the interferometer topology illustrated in FIG. 2, 4A, or 4B. Rather, as will be appreciated by a person having ordinary skill in the art, embodiments of the present invention may be carried out in any suitable common-path interferometry topology. Furthermore, according to one embodiment, transmission media (e.g., optical fiber) may be utilized for transmitting the light beams (i.e., source beam 130, sampling beam 134, probe beam 136, signal beam 138, reference beam 140, and mixed beam 148) described herein. For example, FIG. 6 illustrates a detection system 300 including optical fiber 310 configured for carrying the light beams described herein along their appropriate paths. Accordingly, in an embodiment utilizing optical fiber 301, one or more of reflectors 150A-150G, as described above with reference to FIGS. 2, 4A and 4B, may not be required. Furthermore, specific alignment of component parts within detection system 300 (e.g., non-polarizing beam splitter 118, first quarter-wave plate 120, or second quarter-wave plate 128) may not be required.

Embodiments of the present invention, as described herein, may enable a temporal electrical field of terahertz radiation to be measured. Accordingly, embodiments of the present invention may enable detection of illicit materials via generation and evaluation of terahertz spectra of target materials.

While the present invention has been described herein with respect to certain embodiments, those of ordinary skill in the art will recognize and appreciate that it is not so limited. Rather, many additions, deletions, and modifications to the described embodiments may be made without departing from the scope of the invention as hereinafter claimed, including legal equivalents. In addition, features from one embodiment may be combined with features of another embodiment while still being encompassed within the scope of the invention as contemplated by the inventors.

What is claimed is:

1. A method of detecting terahertz radiation, comprising:
transmitting a reference beam and a signal beam through a common-path interferometer;
transmitting a terahertz beam through a target object;
causing the signal beam and the terahertz beam to simultaneously propagate through an electro-optical element within the common-path interferometer after transmitting the terahertz beam through the target object to induce an optical phase delay between the signal beam and the reference beam;
calculating the phase delay; and
calculating an amplitude of an electric field of the terahertz beam from the phase delay.

2. The method of claim 1, wherein causing the signal beam and the terahertz beam to simultaneously propagate through an electro-optical element within the common-path interferometer after transmitting the terahertz beam through the target object induces a change in an optical phase of the signal beam.

3. The method of claim 1, wherein calculating the phase delay comprises causing the signal beam and the reference beam to interfere.

4. The method of claim 3, wherein causing the signal beam and the reference beam to interfere comprises forming a mixed beam from the signal beam and the reference beam.

5. The method of claim 4, further comprising measuring an intensity of the mixed beam.

6. The method of claim 5, wherein calculating the phase delay comprises calculating the phase delay identified as δφ with the following equation:
$$δφ = \frac{{wn}_{0}^{3} {r}_{41} {E}_{THz} l}{4 c} ;$$
wherein E_{THz} is an amplitude of the signal beam, n₀ is an unperturbed refractive index of the electro-optical element, r₄₁ is a tensor component of the electro-optical element, w is a circular frequency of the reference beam, l is a length of the electro-optical element, and c is the speed of light in a vacuum.

7. The method of claim 6, wherein calculating an amplitude of an electric field of the terahertz beam comprises calculating the amplitude of the electric field of the terahertz beam with the following equation:
$${E}_{THz} = \frac{4 c δφ}{{wn}_{0}^{3} {r}_{41} l} .$$

8. The method of claim 1, further comprising calculating an amplitude of an electric field of the terahertz wave as a function of time.

9. The method of claim 1, wherein the causing of the signal beam and the terahertz beam to simultaneously propagate through the electro-optical element comprises inducing a delay in the signal beam without changing a polarization of the signal beam.

10. The method of claim 1, wherein the causing of the signal beam and the terahertz beam to simultaneously propagate through an electro-optical element comprises simultaneously transmitting the signal beam and the terahertz beam through one of a zinc telluride (ZnTe) crystal and an ammonium dihydrogen phosphate (ADP) crystal.

11. The method of claim 1, wherein the causing of the signal beam and the terahertz beam to simultaneously propagate through the electro-optical element comprises simultaneously transmitting the signal beam and the terahertz beam through a <1 1 0> cut zinc telluride (ZnTe) crystal.

12. The method of claim 1, wherein the causing of the terahertz beam to propagate through the electro-optical element comprises causing an electro-optical change in the refractive index of the electro-optical element.

13. A computer-readable media storage medium storing a plurality of instructions that when executed by a processor cause the processor to perform the plurality of instructions for detecting terahertz radiation, the plurality of instructions comprising:
transmitting a terahertz beam through an object of interest and an electro-optical element;
transmitting a source beam into a common-path interferometer to generate a reference beam and a signal beam, wherein the signal beam and the terahertz beam simultaneously traverse the electro-optical element;
measuring an intensity of a mixed beam formed by interfering the reference beam and the signal beam;
calculating a phase delay between the signal beam and the reference beam from the measured intensity; and
calculating an amplitude of an electric field of the terahertz beam as a function of time from the calculated phase delay.

14. The computer-readable media storage medium of claim 13, further comprising performing a Fourier transform on the calculated amplitude of the electric field as a function of time to generate frequency spectra of the electric field of the terahertz beam.

15. The computer-readable media storage medium of claim 14, further comprising comparing a generated frequency spectra to at least one known frequency spectra of at least one known illicit material to determine if the generated frequency spectra is associated with the at least one known illicit material.

16. A method of detecting terahertz radiation, comprising:
irradiating a target object with a terahertz beam;
inducing a phase delay between a reference beam and a signal beam within a common-path interferometer by simultaneously transmitting the signal beam and the terahertz beam through an electro-optical element in the common-path interferometer;
calculating the phase delay;
determining an amplitude of an electric field of the terahertz beam as a function of time from the phase delay; and
generating frequency spectra from the amplitude of the electric field of the terahertz beam as a function of time.

17. The method of claim 16, wherein inducing a phase delay comprises inducing an electro-optical change in a refractive index of the electro-optical element.

18. The method of claim 16, wherein inducing a phase delay comprises inducing the phase delay between the reference beam and the signal beam without altering a polarization of the signal beam.

19. The method of claim 16, further comprising causing the reference beam and the signal beam to interfere after inducing the phase delay between the reference beam and the signal beam.

20. The method of claim 19, wherein forming a mixed beam from the reference beam and the signal beam comprises causing the reference beam and the signal beam to interfere.

21. The method of claim 20, further comprising measuring an intensity of the mixed beam.

22. The method of claim 16, further comprising comparing the generated frequency spectra to at least one known frequency spectra of at least one known illicit material to determine if the generated frequency spectra is associated with the at least one known illicit material.

23. A detection system, comprising:
a light source configured to transmit a source beam;
an interferometer configured to receive the source beam and including an electro-optical element positioned for receiving a terahertz beam, the interferometer configured to:
generate a signal beam and a reference beam from the source beam;
induce a phase delay between the signal beam and the reference beam in response to the signal beam and the terahertz beam simultaneously traversing the electro-optical element; and
form a mixed beam by interfering the signal beam with the reference beam; and
a sensor configured to measure an intensity of the mixed beam upon receipt thereof.

24. The detection system of claim 23, further comprising a terahertz generation system configured to generate and transmit the terahertz beam through an object of interest.

25. The detection system of claim 24, wherein the terahertz generation system is configured to transmit the terahertz beam in one of a direction perpendicular to a direction in which the signal beam traverses the electro-optical element and a direction parallel to a direction in which the signal beam traverses the electro-optical element.

26. The detection system of claim 23, further comprising a computer operably coupled to each of the sensor and the light source, wherein the computer is configured to control an operation of the light source and receive an output from the sensor.

27. The detection system of claim 23, wherein the sensor comprises a multi-cell photodetector.

28. An interferometer comprising a reference path and a measurement path, wherein the measurement path includes an electro-optical element configured to induce a phase delay in a beam traversing therethrough upon receiving a terahertz beam incident thereon.
